(19) United States
(12) Patent Application Publication
(10) Pub. No.: US 2009/0162604 A1
(43) Pub. Date: Jun. 25, 2009

(54) Knitted Infusion Fabric

(76) Inventor: Georg Adolphs, Sabadell (ES)

Correspondence Address: OWENS CORNING, 2790 COLUMBUS ROAD, GRANVILLE, OH, 43023, US

(21) Appl. No.: 12/093,751

(22) PCT Filed: Nov. 16, 2006
(86) PCT No.: PCT/EP06/68572

§ 371 Date: Oct. 3, 2008

(30) Foreign Application Priority Data
Nov. 18, 2005 (ES) P200502833

(51) Int. Cl. B32B 5/16

(52) U.S. Cl. 428/113; 442/304; 442/308; 442/310; 428/220

(57) ABSTRACT

An infusion fabric is provided including at least one layer of directional reinforcement material knitted with a warp or raschel knitting having a gauge of between about 3 to about 14 and a density of between about 1 to about 10 stitches/cm. A yarn having a diameter of about 0.07 to about 0.5 mm is utilized for the stitching.

### TECHNICAL FIELD AND INDUSTRIAL APPLICABILITY OF THE INVENTION

This invention relates generally to an infusion fabric that may be molded into large composite structures.

### BACKGROUND OF THE INVENTION

Reinforcement fabrics made from fibrous materials formed into woven, knitted and non-woven material, are well known in the art. Yarns of glass, carbon and aramid are typically formed into fabrics, and a plurality of layers of fabric are stacked and cut into dry fabric kits or preforms. The preforms are then infused or impregnated with a resin binder and cured to form a rigid composite.

Typically a glass reinforced fibrous mat is preformed and then placed in a mold for molding into a fiber-reinforced article. Glass fiber-reinforcement mats are used in situations where a desired strength is necessary, such as in truck fenders, auto chassis or bus components and the like. For example, layers of the continuous strand mat and layers of unidirectional or multidirectional reinforcement material are fabricated separately. These layers are individually placed in a set of preformed screens, which generally consist of an upper screen and a lower screen. The upper and lower screens are moved together in order to conform the layers to the shape of the preformed screens. The layers are thus shaped into what is known as a preform. The preform is then placed in a mold and injected with a suitable resinous material to make the fiber reinforced article.

U.S. patent application Ser. No. 10/674,987, filed on Sep. 30, 2003, (OC Case No. 25253) owned by the assignee of the present invention, discloses a crimp-free infusible reinforcement fabric. The unidirectional fabric has small size tows spaced between large size tows. The “channels” that are formed from the small tows between the larger tows permit faster resin infusion and increased productivity.

U.S. patent application Ser. No. 10/971,286, filed on Oct. 22, 2004, (OC Case No. 25454) owned by the assignee of the present invention, discloses an improved infusion fabric that better optimizes knitting, preforming, conformability to tooling, resin infusion rate, consolidation thickness, surface aesthetics, and composite structural performance in a range of closed molding processes including VIP, RTM and RTM Lite or VARTM processes.

The present invention relates to an improved infusion fabric that incorporates one or more plies or layers of directional reinforcement material and at least one other layer of material that are knitted together in a way that provides a fabric with openings or voids between meshes that are positively held open to allow rapid resin infusion.

### SUMMARY OF THE INVENTION

In accordance with the purposes of the present invention as described herein, an infusion fabric is provided comprising at least one layer of directional reinforcement material knitted with knitting having a gauge of between about 3 to about 14 and a density of between about 1 to about 10 stitches/cm using a yarn having a diameter of about 0.05 to about 1.0 mm.

More specifically describing the invention the at least one layer of directional reinforcement material includes uniformly oriented reinforcement fibers. Those fibers may take the form of rovings that are woven to maintain alignment. The layer of directional reinforcement material may be made, for example, from a material selected from a group consisting of glass fibers, aramid fibers, carbon fibers and mixtures thereof. Continuous glass fibers used in the directional reinforcement material layer or layers of the present invention may be selected from a group of materials consisting of E glass, ECR-glass, S glass, A glass and mixtures thereof. The glass fibers typically have a diameter of between about 7.0 to about 40.0 microns.

Aramid fibers used in the construction of the directional reinforcement material layer typically have a denier of about 3.0 to about 5.0.

Carbon fibers useful in the construction of the directional reinforcement material layer typically have a diameter of between about 6.0 to about 8.0 microns.

Each layer of directional reinforcement material typically has an areal weight of between about 100 gr/m² to about 4000 gr/m². The finished infusion fabric typically has an areal weight of between about 3.0 to about 5.0 kg/m².

The yarn utilized to knit the layers together is typically selected from a group of materials consisting of polyethylene terephthalate, polyamide (nylon), polypropylene, polyethylene, polybutylene terephthalate and mixtures thereof. The yarn may be broadly described as having a diameter of between about 0.05 to about 1.0 mm, more typically between about 0.07 to about 0.5 mm and still more typically a diameter of between about 0.13 to about 0.25 mm. The knitting with the yarn may be warp knitting or raschel knitting. Warp knitting may follow any number of patterns including, particularly, tricot, chain and promat and may include between 1 and 196 meshes per square inch. Monofilament yarn is particularly useful in the present invention.

The infusion fabric may include one or more additional layers selected from a chopped fiber mat, a continuous filament mat and combinations thereof. The chopped fibers utilized for the mat may be a natural or synthetic material. For example, the chopped fibers may be made from material selected from a group consisting of glass fibers, carbon fibers, graphite fibers, vitreous carbon fibers, non-graphite carbon fibers, boron monolithic graphite fibers, boron monolithic non-graphite carbon fibers, silicone, aramid, ceramic fibers, thermoplastic polymer fibers, natural fibers (e.g. cotton, kenaf, sisal, jute) and mixtures thereof. Typically the chopped fibers have a length of between about 2.54 and about 10.16 cm and a diameter of between about 9.0 and about 13.0 microns.

In one possible embodiment of the invention the infusion fabric includes a first layer of directional reinforcement material having a first series of axially aligned rovings extending in a first direction and a second layer of directional reinforcement material having a second series of axially aligned rovings extending in a second direction. In one example the first and second directions differ from each other by about 45 degrees. In another example the first and second directions differ from each other by about 90 degrees.

In yet another embodiment the infusion fabric also includes a third layer of directional reinforcement material having a third series of axially aligned rovings extending in a third direction. The third direction differs from the second direction by about 90 degrees and the second direction differs from the first direction by about 45 degrees.

In still another possible embodiment the infusion fabric includes a fourth layer of directional reinforcement material having a fourth series of axially aligned rovings extending in a fourth direction wherein the fourth direction differs from the first direction by about 90 degrees.

In the following description there is shown and described several different embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain certain principles of the invention. In the drawings:

FIG. 1 is a partially sectional perspective view of one possible embodiment of the infusion fabric of the present invention;

FIG. 2 is a detailed plan view of the embodiment illustrated in FIG. 1 illustrating the knitting of the multiple layers of directional material together;

FIGS. 3a-3b, 4 and 5 are partially sectional perspective views of four additional possible embodiments of the infusion fabric of the present invention; and

FIG. 6 is a bar graph illustrating the percent permeability measured for the infusion fabrics of Examples 1-4.

Reference will now be made in detail to the present preferred embodiments of the invention, examples of which are illustrated in the accompanying drawings.

### DETAILED DESCRIPTION AND PREFERRED EMBODIMENTS OF THE INVENTION

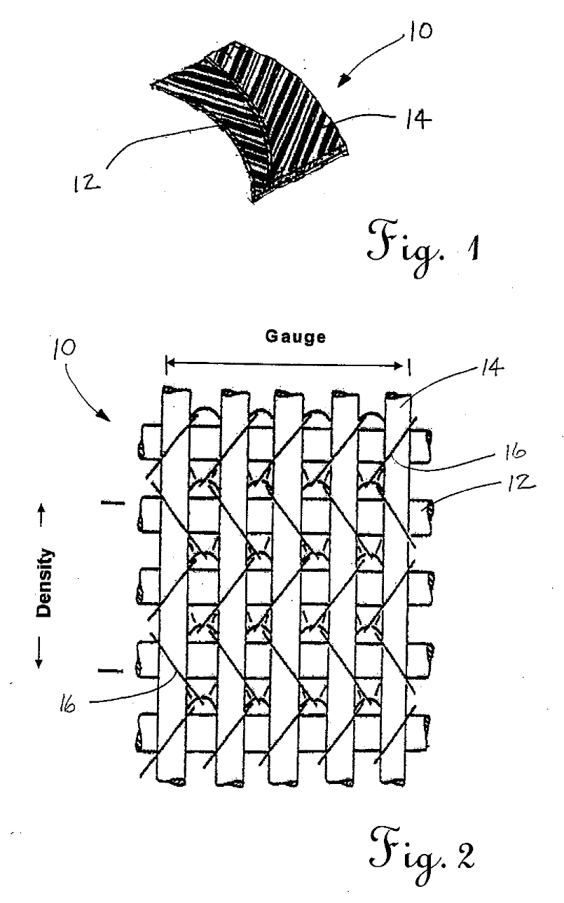

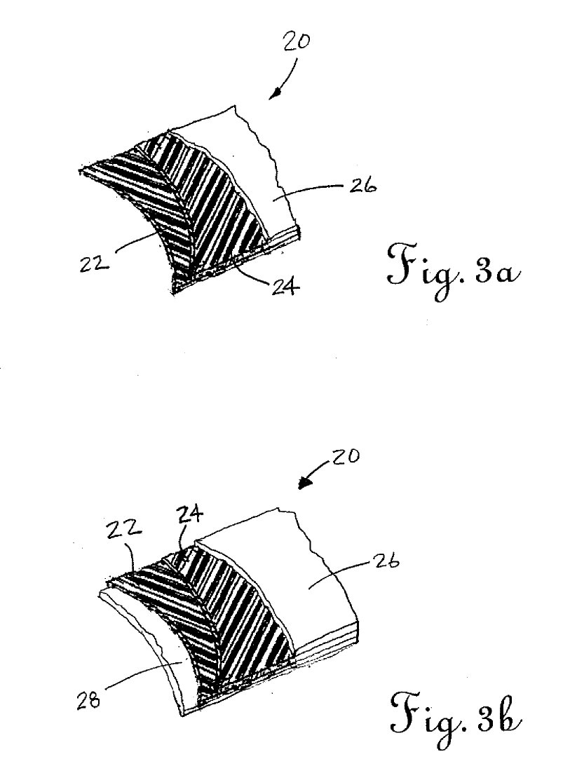

A first embodiment of the infusion fabric 10 of the present invention is illustrated in FIGS. 1 and 2. As illustrated, the infusion fabric 10 includes a first layer 12 of directional reinforcement material and a second layer 14 of directional reinforcement material. Each layer 12, 14 of directional reinforcement material may be woven in, for example, plain, twill or satin style from, for example, glass fibers, aramid fibers, carbon fibers and mixtures thereof. Each layer of directional reinforcement material 12, 14 includes uniformly oriented reinforcement fibers such as parallel rovings or tows that are axially aligned. In the embodiments illustrated in FIGS. 1 and 2 the tows or rovings of the first layer 12 of directional reinforcement material are aligned at an angle of approximately +45 degrees relative to the warp direction while the tows or rovings of the second layer 14 of directional reinforcement material are aligned at an angle of approximately −45 degrees with respect to the warp direction.

In one possible embodiment the first layer 12 of directional reinforcement material includes at least one tow of gun roving interposed between multiple tows of direct roving wherein all the tows of the first layer extend in the first direction. The second layer 14 of directional reinforcement material includes at least one tow of gun roving interposed between multiple tows of direct roving wherein all of the tows of the second layer extend in a second direction where that second direction is oriented approximately 90 degrees away from the first direction. The gun roving is multi-ended and provides capillarity for improved resin transport and infusion rates.

In another possible embodiment the woven roving reinforcement layers 12, 14 each include multiple parallel tows, at least two tows of which have differing yields so as to form spaced channels. The first tow of the two tows may have a yield of between about 750 to about 2500 yds/lb. The second tow of the two tows may have a yield of between about 52 to about 450 yds/lb. By placing one or more of the smaller first tows between two or more of the larger second tows, a channel is provided. These channels allow rapid infusion of resin across the infusion fabric during the molding process.

In yet another embodiment, these concepts are combined and one or both layers 12, 14 include multiple tows of differing yields to form channels. Further, one or more of the tows is formed from gun roving to provide increased capillarity and still further enhance resin infusion.

Glass fibers useful in the production of the layers 12, 14 of directional reinforcement material typically have a diameter of between about 7.0 to about 40.0 microns. The glass fibers used may be of substantially any known type, including but limited to a group of materials consisting of E glass) ECR-glass, S glass, A glass and mixtures thereof. Advantex™ glass fibers available from Owens Corning are just one brand of glass fibers that have been found to be particularly useful in the present invention.

Aramid fibers useful in the construction of the layers 12, 14 of directional reinforcement material typically have a denier of about 3.0 to about 5.0. Kevlar aramid fibers available from DuPont are just one brand of aramid fibers that have been found to be particularly useful in the present invention.

Carbon fibers useful in the construction of the layers 12, 14 of directional reinforcement material typically have a diameter of between about 6.0 to about 8.0 microns. T300 carbon fibers available from Toray are just one brand of carbon fibers that have been found to be particularly useful in the present invention.

The areal weight of each layer 12, 14 of the multiple layers of directional reinforcement material utilized in the infusion fabric 10 is between about 100 gr/m² to about 4000 gr/m². The infusion fabric 10 typically incorporates a number of different layers or plies and has a total areal weight of between about 3.0 to about 5.0 kg/m².

As best illustrated in FIG. 2, the multiple layers 12, 14 of directional reinforcement material are knitted together with warp or raschel knitting having a gauge of between about 3 to about 14 and a density of between about 1 to about 10 stitches/cm using a yarn 16 having a diameter of about 0.05 to about 1.0 mm, more typically about 0.07 to about 0.5 mm and still more typically from about 0.13 to about 0.25 mm. “Gauge” refers to the number of knit yarns per cm measured in the weft (90 degree) direction. “Density” refers to the number of stitches of knit yarn per cm measured in the warp (0 degree) direction.

The yarn 16 utilized may be selected from a group of materials consisting of polyethylene terephthalate, polyamide (nylon), polypropylene, polyethylene, polybutylene terephthalate and mixtures thereof. Further the warp knitting may be performed in a pattern selected from a group consisting of, but not limited to, tricot, chain and promat so as to produce between 1 and 196 meshes per square inch. The yarn 16 may include up to a maximum of ten individual filaments but monofilament yarn is preferred. When yarn 16 of this material and diameter is used to warp or raschel knit the layers 12, 14 of directional reinforcement material at the specified gauge and density, stiff meshes are produced between openings or voids that are positively held open. This substantially increases resin infusion rates while still allowing production of an infusion fabric that provides good mechanical properties in the laminates that result from the various resin infusion processes in which the fabric may be utilized. These processes include VIP, RTM and RTM Lite, VARTM, SCRIMP or CARTM. These processes represent the full range of composite close molding processes used by among others, marine, wind, construction, transportation and industrial customers.

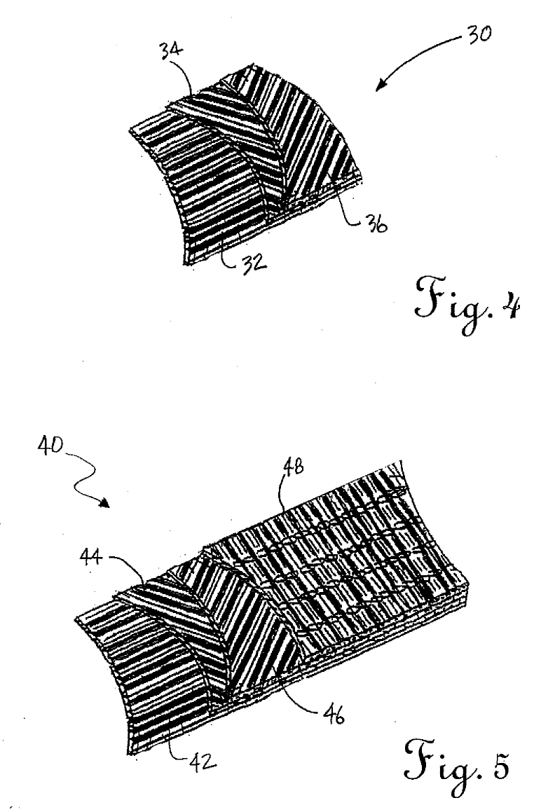

An alternative embodiment of the present invention is illustrated in FIG. 3a. This infusion fabric 20 incorporates multiple layers 22, 24 of directional reinforcement material equivalent to the layers 12, 14 described in the embodiment illustrated in FIGS. 1 and 2. In addition the infusion fabric 20 includes an outer layer 26 constructed from a continuous or chopped fiber mat.

The chopped fibers utilized in the chopped fiber mat 26 may be of natural or synthetic origin. The chopped fibers may, for example, be made from a material selected from a group consisting of glass fibers, carbon fibers, graphite fibers, vitreous carbon fibers, non-graphite carbon fibers, boron monolithic graphite fibers, boron monolithic non-graphite carbon fibers, silicone, aramid, ceramic fibers, thermoplastic polymer fibers, natural fibers (e.g. cotton, kenaf sisal, jute) and mixtures thereof. Typically the chopped fibers have a length of between about 2.54 and about 10.16 cm a diameter of between about 9.0 and about 13.0 microns. Chopped fibers found to be particularly useful in the present invention include ME 3003 and type 495 fibers available from Owens Corning.

Continuous fibers utilized in the continuous fiber mat may be made from, for example, glass fibers, basalt fibers, carbon fibers, graphite fibers, vitreous carbon fibers, non-graphite carbon fibers, boron monolithic graphite fibers, boron monolithic non-graphite carbon fibers, silicone, aramid, ceramic fibers, thermoplastic polymer fibers and mixtures thereof.

In this embodiment the yarn utilized to warp knit the layers 22, 24 of directional reinforcement material together are also utilized to connect the outer layer/chopped fiber or continuous fiber mat 26 to the directional reinforcement material layers 22, 24.

In still another alternative embodiment illustrated in FIG. 3b, a second outer layer 28, made from continuous and/or chopped fiber mat like layer 26, is bonded to the opposite face of the directional reinforcement layers 22, 24 by the warp knitting.

Still another alternative embodiment is illustrated in FIG. 4. More specifically, the infusion fabric 30 of the FIG. 4 embodiment includes a first layer 32 of directional reinforcement material including a first series of axially aligned rovings or tows extending in a first direction, a second layer 34 of directional reinforcement material including a second series of axially aligned rovings or tows extending in a second direction and a third layer 36 of directional reinforcement material including a third series of axially aligned rovings or tows extending in a third direction. In the illustrated embodiment the first direction extends in the warp direction while the second direction extends +45 degrees from the warp direction and the third direction extends −45 degrees from the warp direction. Accordingly, the second and third directions differ by about 90 degrees.

While not illustrated, it should be appreciated that the embodiment illustrated in FIG. 4 may include a single outer layer of chopped fiber mat or continuous fiber mat as illustrated and described with respect to the FIG. 3a embodiment or two outer layers of chopped fiber mats, continuous fiber mats or combinations thereof as illustrated and described with respect to the FIG. 3b embodiment. All layers 32, 34, 36 are knitted together by warp knitting or raschel knitting with yarn in the manner described above with regard to the embodiment illustrated in FIGS. 1 and 2.

Still another embodiment is illustrated in FIG. 5. In this embodiment, the infusion fabric 40 includes first, second, third and fourth layers 42, 44, 46, 48 of directional reinforcement material similar in construction to that described above with respect to layers 12, 14 illustrated in FIGS. 1 and 2. The first layer 42 includes a first series of axially aligned rovings or tows extending in a first direction. The second layer 44 includes a second series of axially aligned rovings or tows extending in a second direction. The third layer 46 includes a third series of axially aligned rovings or tows extending in a third direction. The fourth layer 48 includes a series of axially aligned rovings or tows extending in a fourth direction. In the illustrated embodiment the first direction extends in the warp direction, the second direction extends +45 degrees relative to the warp direction. The third direction extends −45 degrees relative to the warp direction. The fourth direction extends 90 degrees from the warp direction; that is, in the weft direction.

While not illustrated, the embodiment shown in FIG. 5 may also incorporate a single outer layer of chopped fiber or continuous fiber mat as illustrated in FIG. 3a or two such outer layers as illustrated in FIG. 3b, if desired. Once again any and all layers of this embodiment are knitted together with yarn in the manner described above with respect to the embodiment illustrated in FIGS. 1 and 2.

FIGS. 1-5 illustrate several different embodiments for the infusion fabric of the present invention incorporating two, three and four different layers of directional reinforcement material. It should be appreciated, however, that the invention broadly relates to an infusion fabric including only one or any other number of layers of directional reinforcement material. Thus, the invention includes infusion fabric incorporating as many such layers as might be desired directionally oriented in any desired manner to meet the needs of a particular application. No matter how many layers of directional reinforcement material are utilized in the infusion fabric of this invention, they are knitted together with warp knitting having a gauge of between about 3 to about 14 and a density of between about 1 to about 10 stitches/cm using a yarn having a diameter of about 0.05 to about 1.0 mm.

In accordance with this approach, it is possible to produce stiff meshes that serve to hold the voids between the tows or the reinforcement fiber structure positively open to thereby increase resin infusion rates. Advantageously, these improved resin infusion rates are achieved in a fabric that also provides highly regular filament distribution for achieving high mechanical strength in the laminate product. This is true even when the directional fabric is oriented in a direction other than the warp and weft directions. Further, these benefits are achieved without having to add thermoplastic mesh or felt or knit to the laminate. This is significant because such an addition has a tendency to compromise long term mechanical properties.

The following examples are presented for purposes of further illustration and the invention should not be considered as limited thereto.

### EXAMPLE 1

An infusion fabric is constructed from two sheets of Advantex glass fiber directional reinforcement material. The two sheets are oriented at +/−45 degrees. Each sheet comprises 250 gr/m² glass reinforcement where the glass fibers have a diameter of between 16-17 microns and are treated with multicompatible sizing. The two sheets or layers are knitted together using a chain knit pattern with gauge ES and 3.3 mm stitch length (or 3 stitches per cm) utilizing a monofilament yarn of polyethylene terephthalate with a diameter of 0.13 mm.

### EXAMPLE 2

An infusion fabric is constructed from two sheets of Advantex glass fiber directional reinforcement material. The two sheets or layers are oriented at +/−45 degrees. Each sheet includes 250 gr/m² glass reinforcement where the glass has a fiber diameter of 16-17 microns and is treated with multicompatible sizing. The knitting is completed in a tricot pattern with 2.5 mm stitch length (or 4 stitches per cm) using a monofilament yarn of polyethylene terephthalate having a diameter of 0.13 mm.

### EXAMPLE 3

Two layers of Advantex glass directional reinforcement material are knitted together. The two layers are oriented at +/−45 degrees. Each layer includes 250 gr/m² glass reinforcement having a glass fiber diameter of 16-17 microns treated with multicompatible sizing. The knitting is completed in a tricot pattern with 5 mm stitch length (or 2 stitches per cm) using a monofilament yarn of polyethylene terephthalate having a diameter of 0.13 mm or 0.25 mm.

### EXAMPLE 4

An infusion fabric is made from two layers of Advantex glass directional reinforcement material. The layers are oriented at +/−45 degrees and each layer has 250 gr/m² glass reinforcement where the glass fibers have a diameter of 16-17 microns. The fibers are treated with multicompatible sizing. The knitting is completed in a chain pattern with 3.3 mm stitch length (or 3 stitches per cm). The knitting is completed utilizing polyethylene terephthalate 75 tex texturized multifilament sewing yarn.

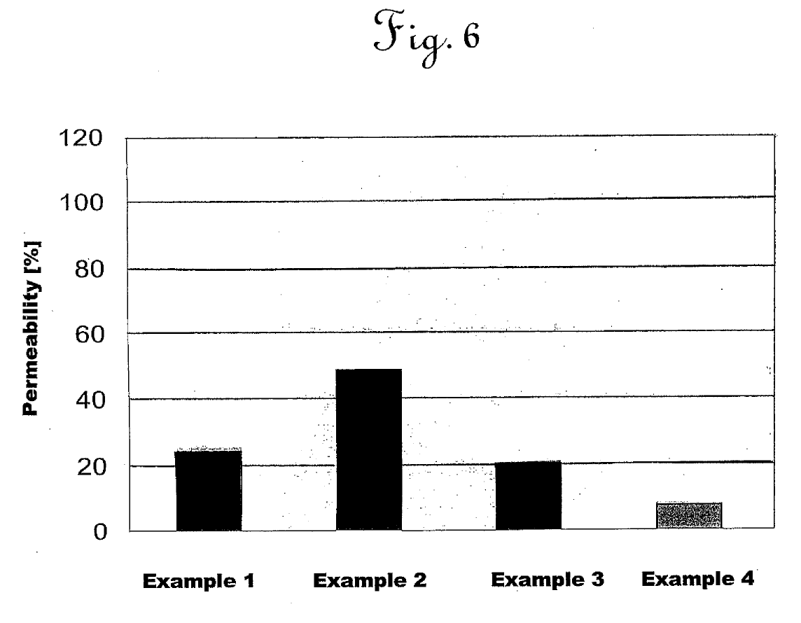

As illustrated in FIG. 6, the infusion fabric of example 2 provides the best percent permeability, almost eight times that as provided by the fabric of example 4. Examples 1 and 3 provide intermediate levels of percent permeability. Thus, permeability may be adjusted to a desired level. The examples suggest that knitting with a monofilament yarn provides the highest permeability.

The foregoing description of the preferred embodiments of the invention have been presented for purposes of illustration and description. It is not intended to be exhaustive or to limit the invention to the precise form disclosed. Obvious modifications or variations are possible in light of the above teachings.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

What is claimed:

1. An infusion fabric comprising at least one layer of directional reinforcement material knitted with knitting having a gauge of between about 3 to about 14 and a density of between about 1 to about 10 stitches/cm using a yarn having a diameter of about 0.05 to about 1.0 mm.

2. The infusion fabric of claim 1, wherein said yarn is a monofilament yarn.

3. The infusion fabric of claim 1, wherein said yarn includes up to ten filaments.

4. The infusion fabric of claim 1 wherein said at least one layer of directional reinforcement material includes uniformly oriented reinforcement fibers.

5. The infusion fabric of claim 4, wherein said uniformly oriented reinforcement fibers are in the form of rovings that are woven to maintain alignment.

6. The infusion fabric of claim 4, wherein said at least one layer of directional reinforcement material is made from a material selected from a group consisting of glass fibers, aramid fibers, carbon fibers and mixtures thereof.

7. The infusion fabric of claim 6, wherein said glass fibers have a diameter of between about 7.0 to about 40.0 microns.

8. The infusion fabric of claim 6, wherein said aramid fibers have a denier of about 3.0 to about 5.0.

9. The infusion fabric of claim 6, wherein said carbon fibers have a diameter of between about 6.0 to about 8.0 microns.

10. The infusion fabric of claim 6, wherein said glass fibers are selected from a group of materials consisting of E glass, ECR-glass, S glass, A glass and mixtures thereof.

11. The infusion fabric of claim 1, wherein said at least one layer of directional reinforcement material has an areal weight of between about 100 gr/m² to about 4000 gr/m².

12. The infusion fabric of claim 11, wherein said infusion fabric has an areal weight of between about 3.0 to about 5.0 kg/m².

13. The infusion fabric of claim 1, wherein said yarn is selected from a group of materials consisting of polyethylene terephthalate, polyamide, polypropylene, polyethylene, polybutylene terephthalate and mixtures thereof.

14. The infusion fabric of claim 13, wherein said yarn has a diameter of between about 0.13 to about 0.25 mm.

15. The infusion fabric of claim 1, wherein said knitting is warp knitting.

16. The infusion fabric claim 1, wherein said knitting is warp knitting in a pattern selected from a group consisting of tricot, chain and promat and including between 1 and 196 meshes per square inch.

17. The infusion fabric of claim 1, wherein said knitting is raschel knitting.

18. The infusion fabric of claim 1, further including one other layer selected from a chopped fiber mat, a continuous filament mat and combinations thereof.

19. The infusion fabric of claim 18, wherein said chopped fibers are natural or synthetic.

20. The infusion fabric of claim 18, wherein said chopped fibers are made from a material selected from a group consisting of glass fibers, carbon fibers, graphite fibers, vitreous carbon fibers, non-graphite carbon fibers, boron monolithic graphite fibers, boron monolithic non-graphite carbon fibers, silicone, aramid, ceramic fibers, thermoplastic polymer fibers, natural fibers (e.g. cotton, kenaf, sisal, jute) and mixtures thereof.

21. The infusion fabric of claim 20 wherein said chopped fibers have a length of between about 2.54 and about 10.16 cm and a diameter of between about 9.0 and about 13.0 microns.

22. The infusion fabric of claim 1, wherein said at least one layer of directional reinforcement material includes a first layer of directional reinforcement material having a first series of axially aligned rovings extending in a first direction and a second layer of directional reinforcement material having a second series of axially aligned rovings extending in a second direction.

23. The infusion fabric of claim 22, wherein said first direction and said second direction differ from each other by about 45 degrees.

24. The infusion fabric of claim 22, wherein said first direction and said second direction differ from each other by about 90 degrees.

25. The infusion fabric of claim 22, wherein said at least one layer of directional reinforcement material includes a third layer of directional reinforcement material having a third series of axially aligned rovings extending in a third direction wherein said third direction differs from said second direction by about 90 degrees and said second direction differs from said first direction by about 45 degrees.

26. The infusion fabric of claim 25, wherein said at least one layer of directional reinforcement material includes a fourth layer of directional reinforcement material having a fourth series of axially aligned rovings extending in a fourth direction wherein said fourth direction differs from said first direction by about 90 degrees.

27. The infusion fabric of claim 13, wherein said yarn has a diameter of between about 0.07 to about 0.5 mm.
